(19) United States
(12) Patent Application Publication
(10) Pub. No.: US 2021/0084912 A1
(43) Pub. Date: Mar. 25, 2021

(54) PRETZEL FOOD PRODUCT WITH REDUCED GLUTEN INTERCONNECTION

(71) Applicant: Campbell Soup Company, Camden, NJ (US)

(72) Inventors: Brad Avory Viands, Hanover, PA (US); Lee Douglas Nauman, Hanover, PA (US)

(21) Appl. No.: 17/030,958

(22) Filed: Sep. 24, 2020

Related U.S. Application Data
(60) Provisional application No. 62/905,071, filed on Sep. 24, 2019.

(51) Int. Cl. A21D 13/40; A21D 2/18; A21D 2/36; A21D 8/02; A23P 30/20

(52) U.S. Cl. CPC A21D 13/40; A21D 2/18; A23P 30/20; A21D 8/02; A21D 2/36

(57) ABSTRACT

Embodiments herein relate to pretzel snack products exhibiting reduced gluten interconnection. In an embodiment, an extruded pretzel snack is included having a three-dimensional structure including a plurality of gluten layers, the three-dimensional structure formed from a dough composition including a wheat flour, a leavening agent, and at least about 5 percent by weight oil content. In an embodiment, a method of making an extruded pretzel snack is included, the method including forming a dough composition including 40 to 70 weight percent of a wheat flour, 20 to 40 weight percent water, 5 to 15 weight percent vegetable oil, and a leavening agent, extruding the dough, cutting the extruded dough to form individual pieces, and proofing the individual pieces, and baking the individual pieces to reduce the moisture content to less than about 5 weight percent. Other embodiments are also included herein.

This application claims the benefit of U.S. Provisional Application No. 62/905,071, filed Sep. 24, 2019, the content of which is herein incorporated by reference in its entirety.

### FIELD

Embodiments herein relate to pretzel snack products. More specifically, embodiments herein relate to pretzel snack products exhibiting reduced gluten interconnection.

### BACKGROUND

Snack foods are a significant segment of the overall food market. The global sweet and savory snack segment is estimated to be over 144 billion dollars in 2018. Sweet and savory snacks include crisps and chips, extruded snacks, popcorn, nut-based snacks, pretzels, fruit snacks, and the like.

Various sensory properties are important to consumers depending on the specific type of snack food. With respect to the crisps, chips and pretzels, in particular, many consumers desire a crunchy eating experience. In many cases, snacks have been fried, giving them a crispy and sometimes crunchy texture. However, some crunchy snacks such as pretzels are typically baked.

Gluten is a family of proteins present in cereal grains, especially wheat, that is responsible for the elastic texture of dough. Wheat gluten proteins are the major storage proteins in mature wheat grain and are deposited in the starchy endosperm cells of the grain. They form a continuous proteinaceous matrix in the cells of the mature dry grain and are brought together to form a continuous viscoelastic network when flour is mixed with water to form dough. These viscoelastic properties underpin the utilization of wheat in the process of making leavened products such as bread and other processed foods.

### SUMMARY

Embodiments herein relate to pretzel snack products exhibiting reduced gluten interconnection. In an embodiment, an extruded pretzel snack is included having a three-dimensional structure including a plurality of gluten layers, the three-dimensional structure formed from a dough composition including a wheat flour, a leavening agent, and at least about 5 percent by weight oil content.

In an embodiment, a method of making an extruded pretzel snack is included, the method including forming a dough composition including 40 to 70 weight percent of a wheat flour, 20 to 40 weight percent water, 5 to 15 weight percent vegetable oil, and a leavening agent, extruding the dough, cutting the extruded dough to form individual pieces, and proofing the individual pieces, and baking the individual pieces to reduce the moisture content to less than about 5 weight percent.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of a pretzel snack in accordance with various embodiments herein.

FIG. 2 is a schematic sectional view of a pretzel snack in accordance with various embodiments herein.

FIG. 3 is a schematic sectional view of a pretzel snack in accordance with various embodiments herein.

FIG. 4 is a schematic sectional view of a pretzel snack in accordance with various embodiments herein.

FIG. 5 is a flowchart of a process in accordance with various embodiments herein.

FIGS. 6A-6E are a series of power spectrum plots showing frequency content of recorded compression sounds of various snacks tested herein.

FIGS. 7A-7E are a series of cumulative plots showing a fraction of sound energy residing at a given frequency for various snacks tested herein.

FIGS. 8A-8E is a series of plots showing sound intensity as a function of time during compression of various snacks tested herein.

FIG. 9 is an image of the structure inside of a baked snack product in accordance with embodiments herein.

FIG. 10 is an image of the structure inside of a baked snack product in accordance with embodiments herein.

FIG. 11 is an image of the structure inside of a baked snack product in accordance with embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As described above, gluten is a family of proteins responsible for the elastic texture of dough. Gluten proteins form a continuous proteinaceous matrix in the cells of the mature dry grain and are brought together to form a continuous viscoelastic network when flour is mixed with water to form dough. These viscoelastic properties are important in the process of using wheat flour to make leavened products such as bread and other processed foods.

Leavened products are characterized by the formation of gases that lead to air pockets within the viscoelastic dough and expansion of the same. However, the gluten that is present generally maintains interconnections resulting in a three-dimensional matrix with air-filled cells. This three-dimensional matrix can be thought of as a honey-comb structure. When the product is dried below a threshold value, the three-dimensional matrix generally becomes quite rigid and structural strong. This generally leads to a product that is crunchy, but may result in a product requiring a degree of chewing force and exhibiting a hardness that exceeds many consumer preferences.

In accordance with embodiments herein, pretzel snacks are made from a dough including a greater than normal portion of oil (such as a vegetable oil). Further, in various embodiments herein, processes such as proofing and baking can be performed for shorter time frames than might be typical of pretzel proofing and baking processes. It has been found that the embodiments herein display properties under compression that are distinct from other pretzel products leading to a crisp product that is not as hard to crunch. Further, it has been found that embodiments herein display a layered gluten structure that lacks the three-dimensional interconnections characteristic of other pretzel products leading to the desirably crisp product that is not as hard to crunch. While not intending to be bound by theory, it is believed that mastication of pretzel snacks herein can proceed more quickly allowing for more rapid bolus formation that for otherwise similar snacks having three-dimensional interconnections.

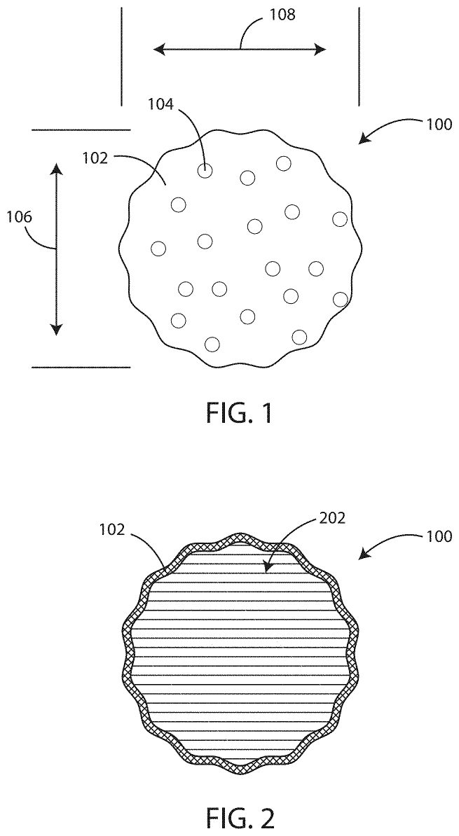

Referring now to FIG. 1, a schematic view of a pretzel snack 100 is shown in accordance with various embodiments herein. The pretzel snack 100 can be or include a three-dimensional structure. In various embodiments, the pretzel snack 100 includes a three-dimensional structure with a circular cross-section. In various embodiments, the pretzel snack 100 includes a three-dimensional structure that is substantially spherical. However, in some embodiments, the pretzel snack 100 may be elongated into a rod-type shape and/or folded into a knotted shape.

While not intending to be bound by theory, it is believed that issues associated with hardness and high levels of chewing force of the product are exacerbated by large dimensions. However, some consumers prefer a more substantially sized snack. Embodiments herein uniquely allow for a desirably crisp product without an overly hard crunch that is still substantial in size. In various embodiments herein, the pretzel snack 100 can have a height 106 and a width 108. In various embodiments, the smallest dimension between the height 106 and the width 108 can be about 2, 3, 4, 5, 6, 7, 8, 9, 10, 12, 15, or 20 mm or an amount falling within a range between any of the foregoing. In various embodiments, the largest dimension between the height 106 and the width 108 can be about 3, 4, 5, 6, 7, 8, 9, 10, 12, 15, 20, or 30 mm or an amount falling within a range between any of the foregoing. The aspect ratio between the height 106 and the width 108 can vary. In some embodiments, the aspect ratio can be about 3:1, 2.5:1, 2:1, 1.5:1, 1.25:1, 1.1:1, or about 1:1 (or a ratio falling within a range between any of the foregoing).

The pretzel snack 100 includes an outer shell 102. The outer shell 102 can be of a deep brown color consistent with consumer expectations for a pretzel product. The outer shell 102 can have a density that is higher than interior portions of the pretzel snack 100. In some cases, the pretzel snack 100 can include salt 104 disposed on the outer shell 102. In some cases, various flavorings (not shown in this view) or other materials can be disposed on the outer shell 102 such as cheese containing flavorings, mustard flavorings, and/or other natural or artificial flavorings, chocolate-based or flavored coatings, frosting, and, in some cases, a component to cause the flavoring to stick to the outer shell 102 such as an oil, a carbohydrate containing composition, or the like. In some embodiments, a composition can be applied to the outer shell 102 in order to render it shinier. By way of example, in some embodiments, an oil or lipid-based composition can be applied to the outer shell 102.

In various embodiments, the density of the pretzel snack 100 herein can be less than an otherwise comparable pretzel product. In some embodiments, the density of the pretzel snack 100 herein can be about less than about 0.2, 0.19, 0.18, 0.17, 0.16, 0.15, 0.14, 0.13, 0.12, 0.11, or 0.1 grams per cubic centimeter, or a density falling within a range between any of the foregoing.

Referring now to FIG. 2, a schematic sectional view of a pretzel snack 100 is shown in accordance with various embodiments herein. As before, the pretzel snack 100 includes an outer shell 102. The pretzel snack 100 also includes a plurality of gluten layers 202. It will be appreciated that the gluten layers 202 are shown schematically in FIG. 2 for ease of illustration. The specific number of gluten layers 202 can be dependent on the overall thickness of the pretzel snack 100. In some embodiments, the gluten layers 202 can be substantially linear and assume a stacked configuration (however, other configurations are contemplated herein such as shown in FIG. 4). In some embodiments, the gluten layers 202 can be substantially aligned with one another. In some embodiments, the gluten layers 202 can be substantially parallel with each other.

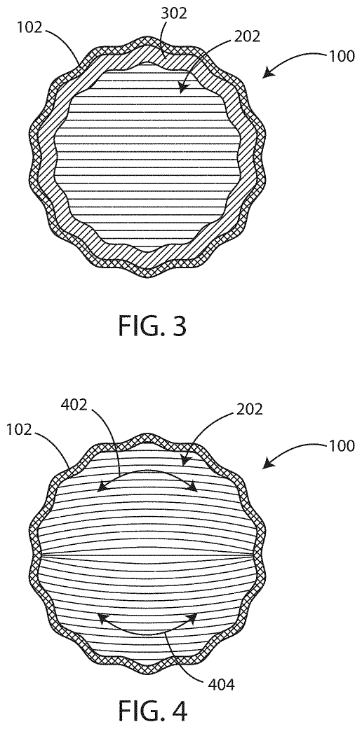

Referring now to FIG. 3, a schematic sectional view of a pretzel snack 100 is shown in accordance with various embodiments herein. The pretzel snack 100 includes an outer shell 102. The pretzel snack 100 also includes a gluten layers 202. The pretzel snack 100 also includes a high-density zone 302. In various embodiments, the density in the high-density zone 302 can be about 10, 20, 30, 50, 75, or 100 percent greater than the density in the interior area (such as measured in grams per cubic centimeter). In some embodiments, the high-density zone can have a thickness of about 0.1, 0.2, 0.5, 1, 2 or 3 mm, or a thickness falling within a range between any of the foregoing. The gluten layers 202 can lack substantial gluten interconnection between layers. The gluten layers 202 can include regions interposed there between substantially lacking gluten or having substantially less gluten than within the layers themselves. The number of gluten layers 202 is not particularly limited, but can be about 4, 8, 12, 16, 20, 30, 40, 60, 100, 200, or 400 or more, or an amount falling within a range between any of the foregoing.

In various embodiments, the pretzel snack 100 has a substantially circular cross-section. In various embodiments, the pretzel snack 100 is substantially spherical. In various embodiments, the plurality of gluten layers are curved. For example, in some embodiments, the gluten layers can exhibit a curvature related to the curvature of the surface of the pretzel snack 100. Referring now to FIG. 4, a schematic sectional view of a pretzel snack 100 is shown in accordance with various embodiments herein. The pretzel snack 100 includes an outer shell 102. The pretzel snack 100 also includes a plurality of gluten layers 202. In this embodiment, the gluten layers 202 includes a top curvature 402. The gluten layers 202 also includes a bottom curvature 404. In various embodiments, the top curvature 402 and the bottom curvature 404 can be substantially identical, but inverted from one another. In various embodiments, the top curvature 402 and the bottom curvature may be different. By way of example, in some embodiments the top curvature 402 can exhibit a greater degree of curvature than the bottom curvature 404. In some embodiments, the top portion can exhibit a top curvature, but the gluten layers at the bottom can be substantially flat.

In various embodiments, the top curvature 402 can be about 0, 5, 7.5, 10, 12.5, 15, 17.5, 20, 22.5, 25, 30, 35, 40, or 45 degrees, or an amount falling within a range between any of the foregoing. In various embodiments, the bottom curvature 404 can be about 0, 5, 7.5, 10, 12.5, 15, 17.5, 20, 22.5, 25, 30, 35, 40, or 45 degrees, or an amount falling within a range between any of the foregoing.

### Methods

Many different methods are contemplated herein, including, but not limited to, methods of making, methods of using, and the like. Aspects of system/device operation described elsewhere herein can be performed as operations of one or more methods in accordance with various embodiments herein.

In an embodiment, a method of making a pretzel snack is included, the method forming a dough composition can include 40 to 70 weight percent of a wheat flour, 20 to 40 weight percent water, 5 to 15 weight percent vegetable oil, and a leavening agent, extruding the dough, optionally cutting the extruded dough to form individual pieces, and proofing the individual pieces, and baking the individual pieces to reduce the moisture content to less than about 5 weight percent.

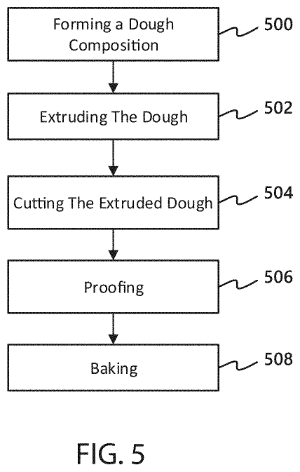

However, it will be appreciated that pretzel snacks herein can be manufactured using various techniques. Referring now to FIG. 5, a flowchart of a process is shown in accordance with various embodiments herein. FIG. 5 shows a method of making 500 a pretzel snack. The method can include an operation of forming 502 a dough composition. The operation of forming 502 the dough composition can include combining dough components (see exemplary dough components described in detail elsewhere herein) and then mixing the same. In some embodiments, all components can be combined substantially at the same time. However, in some embodiments, some components are combined and mixed first followed by other components being added and mixed.

While not intending to be bound by theory, as soon as gluten is combined and mixed with water or another source of moisture, a viscoelastic gluten network will begin to form that can greatly impact resulting texture, firmness, and structure of pretzel snacks herein. In various embodiments, forming the dough composition includes mixing the dough composition (such as after the water or other source of moisture is added) for about 2, 3, 4, 5, 6, 7, or 8 minutes, or an amount of time falling within a range between any of the foregoing. In various embodiments, forming the dough composition includes mixing the dough composition ingredients for between 3 to 6 minutes. In various embodiments, forming the dough composition includes mixing the dough composition ingredients for between 4 to 5 minutes.

In various embodiments, the method can include an operation of extruding 504 the dough. The method can also include an operation of cutting 506 the extruded dough to form individual pieces. However, in some embodiments, extruding and/or cutting operations can be omitted. In some embodiments, the discrete pieces of dough can be placed on a pan or support using other operations or other placement techniques. In various embodiments, no sheeting operations are performed. Surprisingly, it has been identified herein that gluten layers can be formed in the absence of performing a sheeting operation.

The method can include an operation of proofing 508 the individual pieces. Proofing can allow the dough to leaven and expand. Since proofing occurs after the dough composition is formed, the conditions of the proofing step can impact the formation of viscoelastic gluten networks with the dough. In various embodiments, the proofing time is about 0, 1, 1.5, 2, 2.5, 3, 3.5, 4, 4.5, 5, 5.5, 6, 6.5, 7, 7.5, or 8 minutes. In some embodiments, the proofing time can fall within a range between any of the foregoing. In various embodiments, proofing can happen in an environment having an ambient temperature or a temperature greater than ambient such as about 80, 85, 90, 95, 100, 105, 110, 115, 120, 125, or 130 degrees Fahrenheit, or at a temperature falling within a range between any of the foregoing. In various embodiments, proofing can happen in an environment having ambient humidity or at a humidity of about 50, 60, 70, 80, 90, 95, or 98 percent relative humidity, or at a humidity falling within a range between any of the foregoing.

In various embodiments, proofing 508 the individual pieces can include exposing the individual pieces to a caustic bath. The caustic bath can be, for example, a caustic alkaline solution, such as an aqueous solution of sodium hydroxide and/or another base. Individual pieces can be dipped into the caustic bath or the caustic solution can be sprayed on or otherwise applied to individual pieces. In some embodiments, the exposure to the caustic solution can occur prior to forming discrete, individual pieces. In some embodiments the caustic solution can be at approximately room temperature, but in other embodiments the caustic solution may be kept warmer than room temperature.

The method can include an operation of baking 510 the individual pieces. Since baking occurs after the dough composition is formed, the conditions of the baking step can impact the formation of viscoelastic gluten networks with the dough at least until the moisture falls below a threshold amount.

In various embodiments, the operation of baking 510 can occur in an oven with an air temperature of about 200, 220, 240, 260, 280, 300, 320, or 340 degrees Fahrenheit or hotter, or at a temperature falling within a range between any of the foregoing.

In some embodiments, the operation of baking 510 can include to reducing the moisture content to less than about 10, 9, 8, 7, 6, 5, 4 or 3 weight percent, or an amount falling within a range between any of the foregoing.

In various embodiments, the baking time can be about 2, 3, 4, 5, 6, 7, 8, 9, 10, 11, 12, 14 minutes or longer, or an amount of time falling with in a range between any of the foregoing. In some embodiments, the baking time can be from about 4 to 8 minutes.

While not intending to be bound by theory, it is believed that both proofing time and baking time of various embodiments herein can be substantially less than for existing pretzel manufacturing processes and it is believed that this a substantial contributor to desirable properties of embodiments herein.

### Dough Components

Pretzel snack embodiments herein can be formed from a dough including various components. Further details about exemplary dough components are provided as follows. However, it will be appreciated that this is merely provided by way of example and that further variations are contemplated herein.

Exemplary doughs herein include a substantial component of fats (lipids). In various embodiments, an oil can be included to provide all or a substantial part of the fat content. In various embodiments, the oil content can include a vegetable oil. Various types of vegetable oils can be used including, but not limited to, corn oil, sunflower seed oil, safflower oil, canola/rapeseed oil, soybean oil, cottonseed oil, palm oil, palm kernel oil, coconut oil, olive oil, grapeseed oil, hemp oil, peanut oil, and the like, or a combination thereof. In various embodiments, the dough composition can include about 4, 5, 6, 7, 8, 9, 10, 12.5, 15, or 20 percent by weight oil content, or an amount falling within a range between any of the foregoing. In various embodiments, the dough composition can include about 5 to 15 percent by weight oil content.

Exemplary doughs herein include a substantial component of flour, such as wheat flour. Various types and grades of flours can be used herein. In some embodiments, the flour can specifically be a “hard flour”. In some embodiments, the flour can specifically be an “enriched flour”. By way of the example, the flour used can also include components such as niacin, iron (such as reduced iron), thiamine (such as thiamine mononitrate), riboflavin, folic acid, and the like.

In some embodiments, the flour can include a specific amount of gluten. In some embodiments, the flour used herein can include at least about 8, 9, 10, 11, 12, 13, 14, 15, or 16 percent by weight of gluten, or an amount falling within a range between any of the foregoing.

In some embodiments, the dough composition can include a leavening agent. Exemplary leavening agents can include, but are not limited to, biological and chemical leavening agents. Chemical leavening agents typically produce carbon dioxide and water vapor. Chemical leavening agents can include fast-acting, slow-acting, and double-acting chemical leavenings. In some embodiments, leavening agents can specifically include a base (such as ammonium bicarbonate, potassium bicarbonate, or sodium bicarbonate) plus one or more acids or acid salts. Exemplary acids/acid salts can include, but are not limited to potassium acid tartrate (cream of tartar), monocalcium phosphate (MCP), sodium acid pyrophosphate (SAPP), sodium aluminum phosphate (SALP), dicalcium phosphate dihydrate, sodium aluminum sulfate, glucono delta-lactone (GDL), fumaric acid, and the like. In some embodiments, chemical leavening agents herein can include sodium bicarbonate and monocalcium phosphate monohydrate. In some embodiments, chemical leavening agents can include sodium bicarbonate and sodium pyrophosphate. In some embodiments, chemical leavening agents can include sodium aluminum sulfate and monocalcium phosphate. The specific amount of the leavening agent added to the dough depends on the specific nature of the leavening agent. But, in some embodiments, the leavening agent can be at least about 0.01, 0.05, 0.075, 0.1, 0.15, 0.2, 0.3, 0.4, 0.5, 0.75, 1, 1.5, 2, 3, 4, or 5 percent by weight of the dough or an amount falling within a range between any of the foregoing.

The dough composition can include a substantial moisture content. Moisture content can be provided by adding water or another moisture containing component. In some embodiments, the dough composition after mixing and prior to proofing and/or baking can include about 15, 20, 25, 30, 35, 40, 45, or 50 weight percent moisture (water), or an amount falling within a range between any of the foregoing. In various embodiments, the dough composition can include about 20 to 40 weight percent water.

The dough composition can include a malt, malt product, and/or malt extract. By way of example, in some embodiments, the dough composition can include tapioca syrup and/or malt extract. In various embodiments, the dough composition can include at least about 2, 3, 4, 5, 6, 7, 8, 9 or 10 weight percent of a tapioca malt (or other type of malt), or an amount falling within a range between any of the foregoing.

Various other components can also be included in doughs herein including, but not limited to, starches, dough conditioners, fortifying vitamins and minerals, cheese, yeast, salts (sodium chloride, potassium chloride, other sodium, potassium, and/or calcium salts), milk, yeast, spices, natural and artificial flavorings, antioxidants, microbial growth inhibitors, and the like.

In various embodiments, the three-dimensional structure is formed from a dough composition can include 40 to 70 weight percent of a wheat flour, 20 to 40 weight percent water, 5 to 15 weight percent vegetable oil, and a leavening agent.

### Functional Properties

Various embodiments herein include a variety of desirable functional properties. Further details about exemplary functional properties are provided as follows. However, it will be appreciated that this is merely provided by way of example and that further variations are contemplated herein.

In various embodiments, the pretzel snack exhibits a gradient under compression of about 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100 or 9200 (g/s), or an amount falling within a range between any of the foregoing.

In various embodiments, the pretzel snack exhibits a linear distance under compression of about 7000, 7500, 8000, 8500, 9000, 9500 or 10,000 (g s), or an amount falling within a range between any of the foregoing.

In various embodiments, the pretzel snack exhibits an average dropoff force under compression of about 300, 350, 400, 450, 500, 550 or 600 (g), or an amount falling within a range between any of the foregoing.

In various embodiments, the pretzel snack exhibits a maximum force under compression of about 2500, 2600, 2700, 2800, 2900, 3000, 3100, 3200, 3300, 3400, 3500, 3600, 3700, 3800, 3900, or 4000 (g), or an amount falling within a range between any of the foregoing.

In various embodiments, the pretzel snack exhibits an average sound intensity under compression of about 325, 350, 375, 400 or 425 (au), or an amount falling within a range between any of the foregoing.

In various embodiments, the pretzel snack exhibits an average number of sound peaks under compression of about 7, 8, 9, 10, 11, 12, or 13, or an amount falling within a range between any of the foregoing.

In various embodiments, the pretzel snack exhibits a sound amplitude spectrum wherein at least 40, 42, 44, 46, 48, 50, 52, 54, 56, 58, or 60% (or an amount falling within a range between any of the foregoing) of the total sound is at frequencies of 1000 Hz or less.

In various embodiments, the pretzel snack exhibits a sound intensity profile under compression with at least 50, 60, 70, 75, 80, 85, 90, or 95% (or an amount falling within a range between any of the foregoing) of total sound intensity occurs within 0.3, 0.4, 0.5, 0.6, 0.7, 0.8, 0.9, 1, 1.5, or 2 seconds (or an amount of time falling within a range between any of the foregoing) of initial compression.

While not intending to be bound by theory, it is believed that mastication of pretzel snacks herein can proceed more quickly allowing for more rapid bolus formation that for otherwise similar snacks having three-dimensional interconnections. In various embodiments, mastication of pretzel snacks herein and/or bolus formation can be about 5, 10, 20, 30, 40, 50, 75, or 100 percent or more faster than for an otherwise similar pretzel snack lacking a plurality of gluten layers as described herein.

Aspects may be better understood with reference to the following examples. These examples are intended to be representative of specific embodiments, but are not intended as limiting the overall scope of embodiments herein.

### EXAMPLES

The snacks in accordance with embodiments herein were tested by both mechanical and acoustical means. The internal structure was examined by microscopic techniques.

The tested sample that is exemplary of embodiments herein is referred to below as “Pretzel Rounds”. These were analyzed and compared with other products including Snyder's of Hanover Olde Tyme Pretzels, Snyder's of Hanover Mini Pretzels, Snyder's of Hanover Sourdough Hard Pretzels and Jellybean Foods Pretzel Balls.

### Example 1: Mechanical Tests

Individual snack items were placed on the base platform of a StableMicrosystems TX.AT plus texture analyzer. An 8 mm cylindrical probe compressed the samples at a rate of 2 mm/s and to a distance of 5 mm. The probe was chosen to simulate the cross-sectional area of a molar and be most similar to an initial bite. FIG. 1 shows an example of the force response curves over time for the snack items. In general, the items produce a jagged response curve. This is typical of snack items as they exhibit multiple fractures under compression, and this phenomenon is part of what produces the sensation of crispness or crunchiness.

Initial Gradient: measures the initial build-up of force before the item first fractures. This is most related to the elastic modulus of the solid material, thus is one measure of initial hardness experienced on the first bite.

Number of Fracture Peaks: As noted, crisp foods break at multiple levels during continued compression. The number of fracture events varies with the item and can be an indicator of how the snack comes apart, and would be a qualitative indicator of the crispness sensation.

Linear Distance: In general, crisp and crunchy items have very jagged response curves. In comparison, ductile or elastic items would have a very smooth response of force with distance. On way of measuring the noisy response is through the “linear distance” algorithm. This measures the total length travelling point to point through the data. Thus, higher numbers correspond to more noisy or jagged response curves.

Average Drop-off: After a fracture a large part of the structure may remain intact, or parts may give way. A large drop-off force indicates that much of the structure is separated after fracture.

Maximum Force: In the course of a compression, some maximum force is realized. This is due to a combination of the inherent hardness of the sample, and how much it fractures and clears when compressed.

Mechanical data collected is shown below in TABLE 1:

TABLE 1

| | | | | Linear | Avg. | Max. |
|---|---|---|---|---|---|---|
| | | Gradient | No. of | Distance | Drop Off | Force |
| | | (g/s) | Peaks | (g s) | Force (g) | (g) |
| Hard Pretzels | Mean | 14989 | 19.8 | 34124 | 752.4 | 6998 |
| | St. Dev. | 3545 | 3.6 | 9635 | 289 | 1800 |
| Mini Pretzels | Mean | 8548 | 21.6 | 22823 | 327.2 | 2179 |
| | St. Dev. | 2474 | 3.4 | 4862 | 83 | 884 |
| Olde Tyme | Mean | 8255 | 15.4 | 9767 | 302.6 | 3341 |
| | St. Dev. | 1660 | 4 | 1714 | 106 | 765 |
| Pretzel Balls | Mean | 13473 | 10.7 | 16298 | 1116 | 6138 |
| | St. Dev. | 2854 | 5.3 | 3116 | 1356 | 1688 |
| Pretzel Rounds | Mean | 7995 | 11.5 | 8427 | 450.4 | 3253 |
| | St. Dev. | 2171 | 5 | 1662 | 254 | 946 |

The Hard Pretzels and Pretzel Balls had the greatest initial gradient (14,989 and 13,473 g/s), and might be expected to have the greatest perceived hardness on initial biting. The gradient did not differ amongst the Mini Pretzels, Olde Tyme Pretzels and Pretzel Rounds (7995-8548 g/s).

The Hard and Mini Pretzels had the greatest number of fracture peaks (19.8-21.6) followed by the Olde Tyme pretzels (15.4). The Pretzel Balls and Rounds had the fewest fracture peaks (10.7-11.5) suggesting these had the least number of cracks or breaks during compression. This indicates that the Hard and Mini Pretzels were more brittle in total, suggesting that they break over shorter distances when stressed.

All samples were significantly different for linear distance. This analysis is used by Texture Technologies to assess crispness, as it measures overall jaggedness of the force-distance curve. In order (from highest to lowest): Hard Pretzels (34,124 g s), Mini Pretzels (22,823 g s), Pretzel Balls (16,298 g s), Olde Tyme Hard Pretzels (9767 g s), and Pretzel Rounds (8427 g s).

Average Drop Off Force measures the average change in force after individual breaks occur. Thus, a higher drop off force indicates that once a break starts, the sample tends to fracture completely and fall apart. Highest values were for the Pretzel Balls (1116 g) and Hard Pretzels (752.4 g). The other samples did not differ significantly (302.6-450.4 g).

Finally, the maximum measured force was greatest for the Hard Pretzels and Pretzel Balls (6138-6998 g), intermediate for the Olde Tyme and Pretzel Rounds (3253-3341 g) and least for the Mini Pretzels (2179 g).

This example shows that the pretzel snacks of embodiments herein were substantially different than other tested snacks, including other tested pretzel snacks. It should be noted that the Mini Pretzels included less than 1 wt. % of a vegetable oil and the Olde Tyme Pretzels included less than 3.5 wt. % while the Pretzel Rounds included roughly 6 wt. %. Further the Mini Pretzels included less than 1 wt. % of a tapioca malt and the Olde Tyme Pretzels included less than 1.5 wt. % while the Pretzel Rounds included roughly 5.3 wt. %. Thus, this example shows that vegetable oil context significantly impacted physical properties of the resulting pretzel snack. In addition, the proofing time for the Pretzel Rounds was approximately 18% less than for the Mini Pretzels and 35% less than for the Olde Tyme Pretzels. Further, the baking time for the Pretzel Rounds was approximately 22% less than for the Mini Pretzels and 43% less than for the Olde Tyme Pretzels. Thus, this example also shows that proofing time and baking time significantly impacted physical properties of the resulting pretzel snack.

### Example 2: Acoustic Tests

The product sounds were also recorded while the snack items were being collected. The sounds were recorded using an Audix testing microphone positioned 2 cm from the compression probe. Sounds were collected during the compression, then trimmed to include the 2.5 s after the probe contacted the sample surface. The sound files were analyzed using a MatLab program.

In general, the files show a fluctuating noisy sound amplitude over time. The sounds are typically noisy as they contain many frequency components (pitches). These arise as the material fractures, releasing stored mechanical energy as sound. These sounds occur chaotically and with different magnitudes and frequencies. The noisy sound is also a determinant of crisp/crunch sensations. Several features were analyzed:

Overall Sound Intensity: The overall sound intensity was determined by integrating the sound data over the collection period. In general, louder sounds would be associated with greater crispness/crunchiness levels.
Number of Peaks: As with mechanical fracture peaks, the sound peaks correspond with individual breakages and many peaks would be expected in order to create a crispness sensation during compression. It should be noted that the peaks are determined as local maximum occurring above some threshold value.
Periodograms: Crispness and crunchiness are also characterized by the relative collection of frequencies they contain. This can be determined by Fast Fourier Transformation of the time domain data, and displaying a spectrogram of how the frequency contents vary with time.

Alternately, the total data over time can be analyzed. The power spectral density plot displays this as the relative weighted energy of each frequency.

Sound data collected is shown below in TABLE 2.

TABLE 2

| | Avg. Intensity | | Number of Peaks | | |
|---|---|---|---|---|---|
| | Avg. | St. Dev. | Avg. | St. Dev. | % <1700 Hz |
| Hard Pretzels | 484.8 | 217 | 33.3 | 19.6 | 35.3 |
| Mini Pretzels | 393.4 | 103.7 | 18 | 4.1 | 31.5 |
| Olde Tyme | 328.3 | 31.5 | 9.5 | 4.3 | 41 |
| Pretzel Balls | 570.3 | 123 | 21.3 | 13.8 | 60.4 |
| Pretzel Rounds | 378.9 | 142 | 9.4 | 4.2 | 54.8 |

The Hard Pretzels and Pretzel Balls generated the greatest overall sound intensity (484.8-570.3 au). Olde Tyme and Pretzel Rounds produced the least sound intensity. In general, the loudness of sounds produced by biting are correlated with the perceived intensity of crispness/crunchiness.

The Hard Pretzels had the greatest number of sound peaks (33.3) followed by the Pretzel Balls (21.3). This indicates that there are multiple fractures during compression that contribute to a sustained sound level in these products. The Olde Tyme and Pretzel Round snacks had the fewest peaks (9.4-9.5).

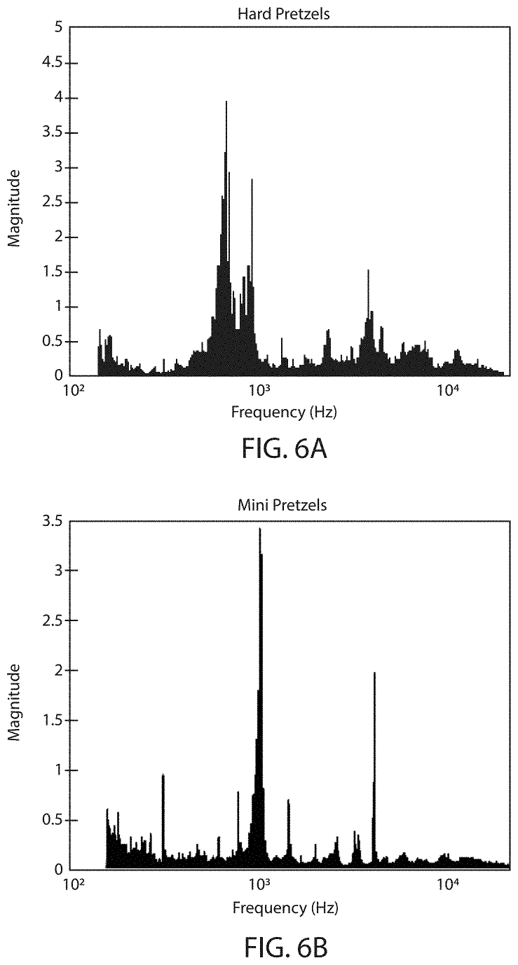

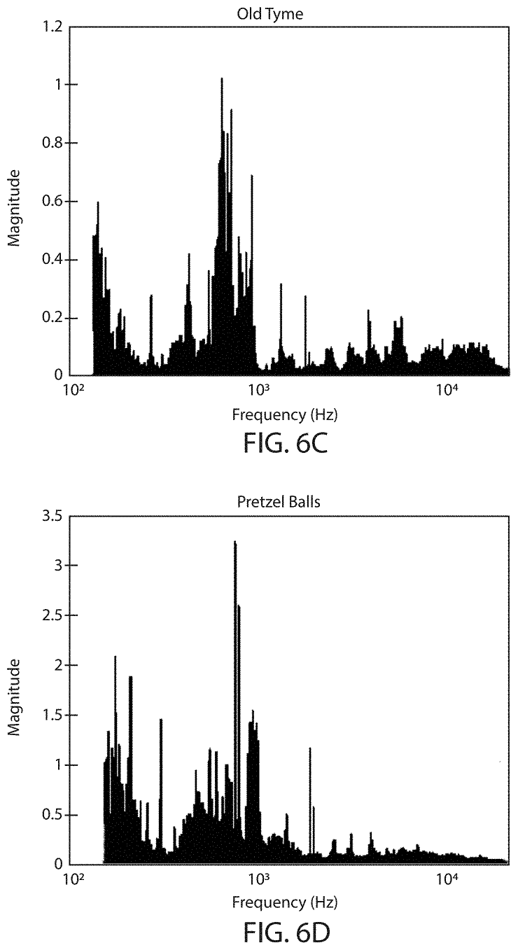

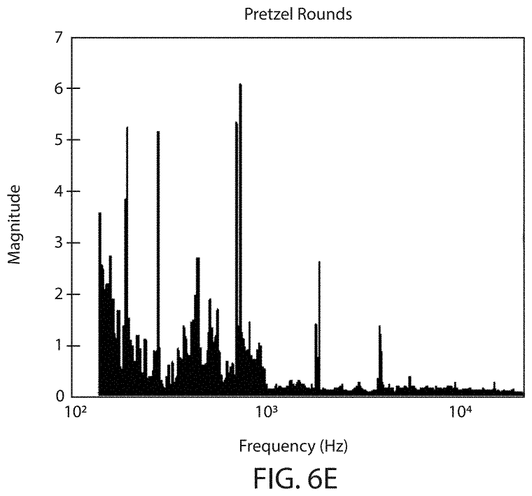

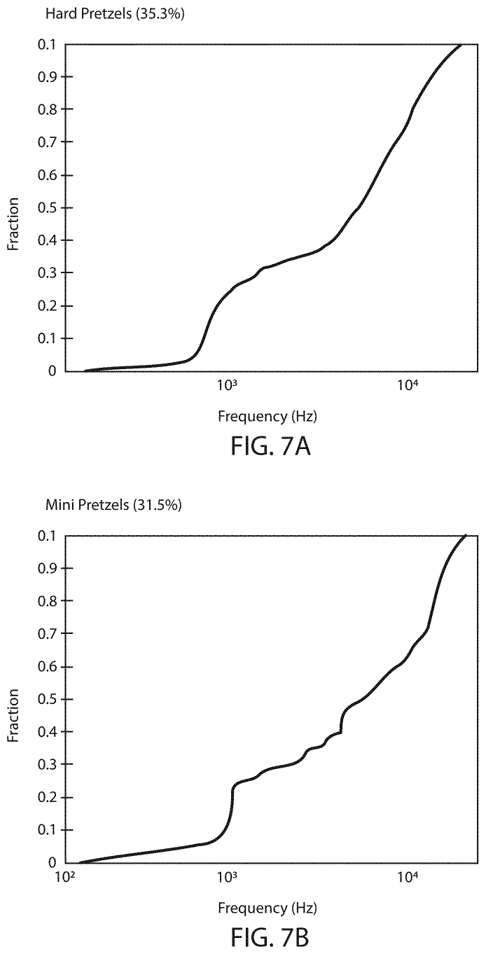

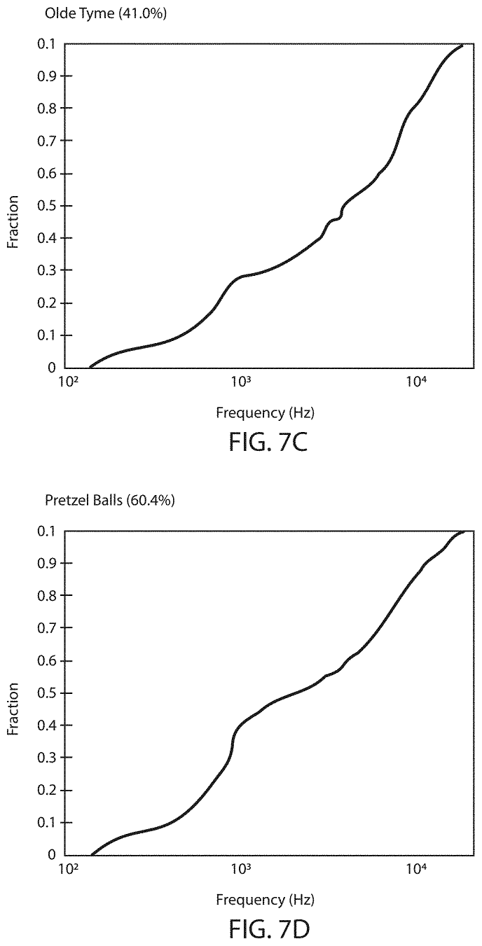

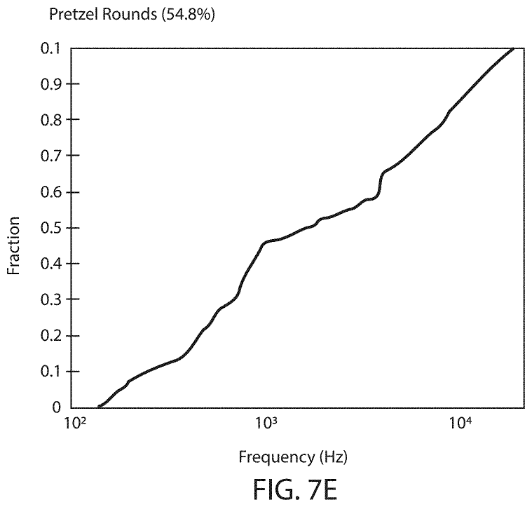

It has been suggested that the sensations of crispness or crunchiness might be related to the frequency (pitch) components contained in the audio signal. However, this does vary with the type of food tested. Typically a frequency in the region of 1.6-1.9 kHz has been used as a marker. That is, crunchy foods often have more of their frequency content below the cut-off, crisper foods have more frequencies above the cut-off. FIGS. 6A-6E shows averaged power spectrum plots for each of the snacks tested. This shows an x-axis (on a log scale) consisting of the frequency spectrum (here between 100 and 20,000 Hz). The y-axis shows the relative weights of each of those frequencies. In general, crisp/crunchy items will have many frequency components and that is why they sound “noisy”. In addition, the spectra were reanalyzed to determine a cumulative frequency plot (FIGS. 7A-7E). This curve shows for any given frequency, what fraction of

the signal lies below that frequency.

The Hard and Mini Pretzels contained fewer frequency components below 1700 Hz, with 35.3 and 31.5% of the sound energy below this value, respectively. The Hard Pretzels had very little energy below 600 Hz, but did have major peaks in the 800-1200 Hz region. The Pretzel Balls and Rounds had more of their acoustic energy below 1700 Hz, with 60.4 and 54.8%. This suggests that the Balls and Rounds have a generally lower pitched noise when compressed and would be more likely to be perceived as crunchy on the crispness-crunchiness spectrum. It is of interest that both have similar round shape and size, and perhaps the structure encourages the fracture mechanics that lead to enhancement of lower frequencies.

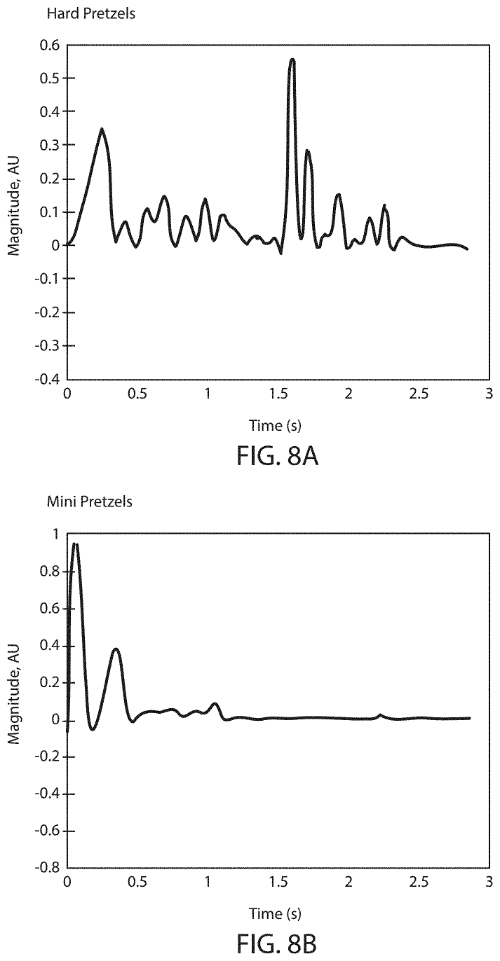

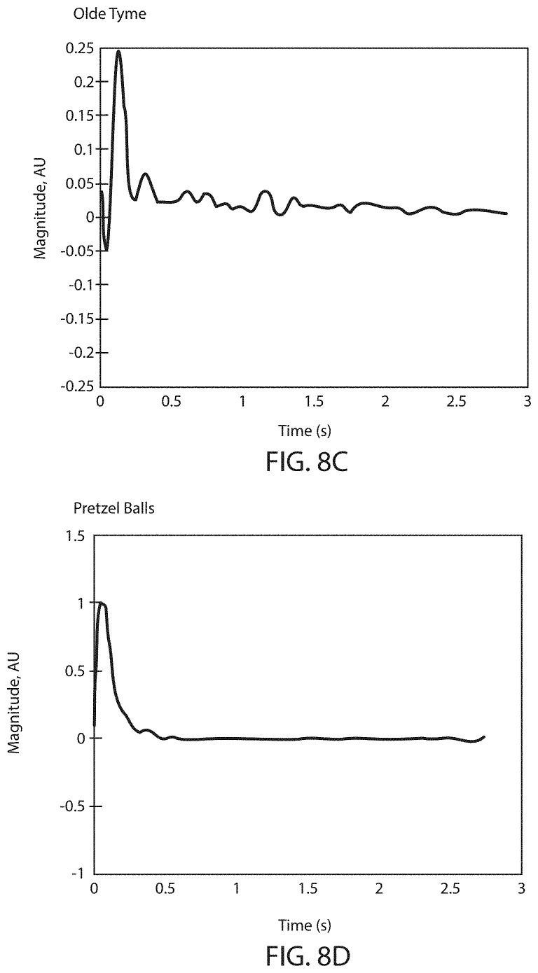

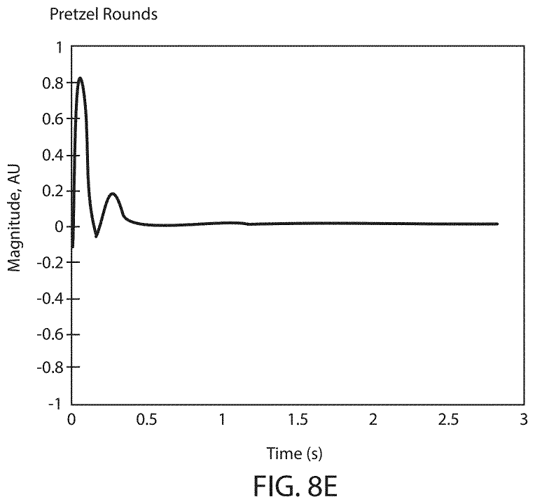

A look at how the sound level changed during the course of compression was also instructive (FIGS. 8A-8E). For the Hard Pretzels in particular, the sound peaks were distributed over all of the 3 s period. This was also true for the Olde Tyme, and to a lesser extent, the Mini Pretzels. For the Pretzel Balls and Rounds, however, most of the peaks were witnessed within the first 0.5 s.

### Example 3: Microscopy

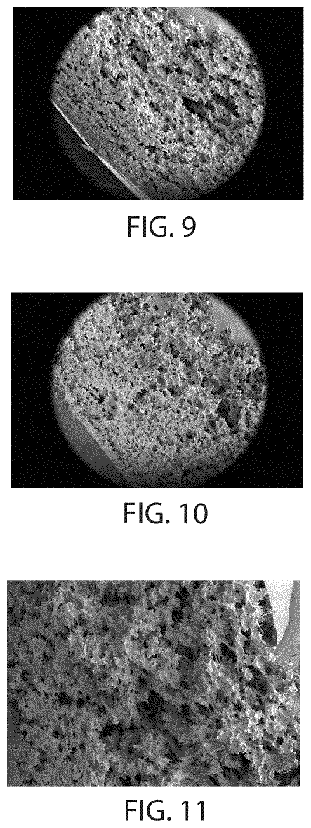

The test snack products herein were also evaluated using microscopy to evaluate their texture and internal structure. FIG. 9 is an image of the structure inside of the Pretzel Rounds product. A plurality of layers can be seen in this view that correspond to gluten layers.

FIG. 10 is an image of the structure inside of the Pretzel Balls product. This view shows that the internal structure lacks distinct layers and that gluten therein is interconnected in all directions. FIG. 11 is an image of the structure inside of the Olde Tyme product. This view shows that the internal structure lacks layers and that gluten therein is interconnected in all directions.

It should be noted that, as used in this specification and the appended claims, the singular forms “a,” “an,” and “the” include plural referents unless the content clearly dictates otherwise. Thus, for example, reference to a composition containing “a material” includes a mixture of two or more materials. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. An extruded pretzel snack comprising:
a three-dimensional structure comprising a plurality of gluten layers, the three-dimensional structure formed from a dough composition comprising
a wheat flour;
a leavening agent; and
at least about 5 percent by weight oil content.

2. The extruded pretzel snack of claim 1, the dough composition comprising about 25 to 40 weight percent water.

3. The extruded pretzel snack of claim 1, the dough composition comprising about 5 to 15 percent by weight oil content.

4. The extruded pretzel snack of claim 3, wherein the oil content comprises a vegetable oil.

5. The extruded pretzel snack of claim 1, wherein the extruded pretzel snack exhibits a gradient under compression of about 6800 to 9200 (g/s).

6. The extruded pretzel snack of claim 1, wherein the extruded pretzel snack exhibits a linear distance under compression of about 7000 to 10,000 (g s).

7. The extruded pretzel snack of claim 1, wherein the extruded pretzel snack exhibits an average dropoff force under compression of about 300 to 600 (g).

8. The extruded pretzel snack of claim 1, wherein the extruded pretzel snack exhibits a maximum force under compression of about 2500 to 4000 (g).

9. The extruded pretzel snack of claim 1, wherein the extruded pretzel snack exhibits an average sound intensity under compression of about 325 to 425 (au).

10. The extruded pretzel snack of claim 1, wherein the extruded pretzel snack exhibits an average number of sound peaks under compression of about 7 to 13.

11. The extruded pretzel snack of claim 1, wherein the extruded pretzel snack exhibits a sound amplitude spectrum comprising at least 40% of the total sound at 1000 Hz or less.

12. The extruded pretzel snack of claim 1, wherein the extruded pretzel snack exhibits a sound intensity profile under compression with at least 80% of total sound intensity occurring within 0.5 seconds of initial compression.

13. The extruded pretzel snack of claim 1, wherein the three-dimensional structure has a circular cross-section.

14. The extruded pretzel snack of claim 1, wherein the three-dimensional structure is substantially spherical.

15. The extruded pretzel snack of claim 1, wherein the plurality of gluten layers are curved.

16. The extruded pretzel snack of claim 1, wherein at least some of gluten layers exhibit a curvature of at least 45 degrees.

17. The extruded pretzel snack of claim 1, wherein the three-dimensional structure is formed from a dough composition comprising
40 to 70 weight percent of a wheat flour;
20 to 40 weight percent water;
5 to 15 weight percent vegetable oil; and
a leavening agent.

18. A method of making an extruded pretzel snack comprising:
forming a dough composition comprising
40 to 70 weight percent of a wheat flour;
20 to 40 weight percent water;
5 to 15 weight percent vegetable oil; and
a leavening agent;
extruding the dough;
cutting the extruded dough to form individual pieces; and
proofing the individual pieces; and
baking the individual pieces to reduce the moisture content to less than about 5 weight percent.

19. The method of claim 18, wherein the proofing time is from 2 to 6 minutes.

20. The method of claim 18, wherein the baking time is from 4 to 8 minutes.
